(19) United States
(12) Patent Application Publication
(10) Pub. No.: US 2019/0283906 A1
(43) Pub. Date: Sep. 19, 2019

(54) LUNAR BASE SUPPLY METHOD, LIGHT INDICATION METHOD, AND FIREWORK BALL

(71) Applicant: EME CORPORATION, Tokyo (JP)

(72) Inventors: Houta IMAJYO, Tokyo (JP); Anna IMAJYO, Tokyo (JP); Ayata IMAJYO, Tokyo (JP); Hirotaka IMAJYO, Tokyo (JP); Yasutaka IMAJYO, Tokyo (JP)

(21) Appl. No.: 16/354,409

(22) Filed: Mar. 15, 2019

(30) Foreign Application Priority Data
Mar. 16, 2018 (JP) 2018-49543
May 28, 2018 (JP) 2018-101726

(51) Int. Cl. B64G 1/24; B64G 99/00; B64G 1/10; F42B 4/26

(52) U.S. Cl. CPC B64G 1/242; F42B 4/26; B64G 1/10; B64G 9/00

(57) ABSTRACT

A lunar base supply method which enables supplying a base on a surface of the moon more easily than carrying materials from the earth to the moon and building the base on the surface of the moon. The lunar base supply method includes the steps of: (a) carrying materials to be used to build a structure to sky of the earth, and causing the materials to revolve along an orbit around the earth; (b) building the structure by using the materials on the orbit around the earth; and (c) moving the built structure from the orbit around the earth toward the moon, and causing the built structure to make a soft landing onto a surface of the moon and thereby to be available as a base.

### CROSS-REFERENCE TO RELATED APPLICATION

The present application claims priority from Japanese Patent Applications No. 2018-49543 filed on Mar. 16, 2018 and No. 2018-101726 filed on May 28, 2018, the contents of which are incorporated herein by reference in their entirety.

### BACKGROUND OF THE INVENTION

### Field of the Invention

The present invention relates to a lunar base supply method of supplying a base on a surface of the moon. Further, the present invention relates to a light indication method of indicating light by sending a light source such as a firework ball toward the sky of an objective point, and relates to a firework ball to be used in such a light indication method.

### Description of a Related Art

For the purpose that a spacecraft navigates to a planet (e.g., Mars) other than the earth, it is considered to provide a base on the moon in which the attracting force is about ⅙ of that in the earth, and that the spacecraft navigates between the lunar base and Mars. Although there is no atmosphere on the moon and there is a risk of being exposed to a large amount of cosmic rays (radiation), it is possible to guard oneself against the cosmic rays by using the lunar base.

Generally, fuel consumption in a flying object such as the spacecraft become remarkable when a velocity of the flying object makes a big change. That is, a large amount of fuel is consumed when the flying object accelerates for takeoff and when the flying object decelerates for landing. Further, the larger the total mass of the flying object becomes, the larger amount of fuel the flying object consumes. Accordingly, so-called Snowman phenomenon is caused in which if the flying object mounts a large amount of fuel for landing, the total mass of the flying object becomes large according thereto, and the flying object must mount a larger amount of fuel for takeoff.

As a related art, Patent Document 1 discloses a method which enables saving mass of the fuel to be mounted for an interplanetary mission such as investigating Mars. The method consists of launching a first orbiting spacecraft from the earth onto a first interplanetary transfer orbit toward an objective planet to be investigated; launching a second orbiting spacecraft from the earth onto a second interplanetary transfer orbit toward a meeting spot; collecting a cargo to be carried and loading it in the first orbiting spacecraft; causing the first orbiting spacecraft and the cargo to return from the objective planet to the meeting spot; docking the two orbiting spacecrafts; and causing at least the second orbiting spacecraft and the cargo to return from the meeting spot to an orbit of the earth.

According to Patent Document 1, on the way of the first orbiting spacecraft returning to the earth, the first orbiting spacecraft joins to the second orbiting spacecraft at the meeting spot and the two orbiting spacecrafts are connected together. Next, when the two orbiting spacecrafts return together to the earth, the second orbiting spacecraft provides fuel which is necessary for the connected two orbiting spacecrafts to return, brake, and approach an orbit around the earth. Accordingly, the first orbiting spacecraft does not need to mount a large amount of fuel for landing.

As disclosed in Patent Document 1, in the case of investigating Mars, if two spacecrafts are connected together at the meeting spot, it is possible to save the fuel to be mounted on the spacecraft which reaches Mars. Further, it is considered that the lunar base is used as the meeting spot because the fuel consumed in landing on the moon or taking off from the moon is less than that consumed in landing on the earth or taking off from the earth.

However, the moon and the earth are apart at a distance of about 380,000 km. Accordingly, in the case of providing a base on the moon, if materials to be used to build the base are carried from the earth to the moon and the base is built on the surface of the moon, personnel who build the base also must go and return between the earth and the moon, and this brings a big burden. Further, a large amount of fuel becomes necessary to carry the personnel who build the base by using a spacecraft.

By the way, in order to inform opening of an event and so on, it is performed to indicate light by sending a light source such as a firework ball toward the sky of an objective point. For example, rocket fireworks are widely used in also other than a firework display. Generally, a firework ball to be used for the rocket firework is manufactured by packing a plurality of “stars”, which are made by molding explosive powder and so on in spherical shapes, together with “split explosive” into a spherical case made of paper and called “ball skin” or “ball shell”, and connecting a fuse to the split explosive.

For example, by setting explosive powder for launch on a bottom of a cylinder directed upward, putting a firework ball thereon, and igniting the explosive powder for launch, the firework ball is launched and the fuse catches fire. The firework ball rises while the fuse is burning. At a certain altitude in the sky, the split explosive catches fire from the fuse, and the split explosive explodes. Thereby, a plurality of stars are scattered in many directions while emitting lights in predetermined colors, and express petals of a firework in the sky.

As a related art, Patent Document 2 discloses a rocket firework ball which enables reducing waste of the ball skin after launch and preventing accidental firing caused in the case where setting of explosive powder for launch is forgotten. The rocket firework ball includes, in order from the center, split explosive 3, stars 4, and ball skins 5-8 in a stack, and is characterized in that a layer of explosive powder for launch 8 is provided as the outermost layer of the ball skins 5-8.

The layer of explosive powder for launch 8 includes explosive powder for launching the firework ball 1 and finishes burning in a moment, and therefore, it burns out without burning the adjacent ball skin 7. The layer 8 generates, when burning, a large amount of gas, and the gas fills a launch cylinder and pushes the firework ball 1 up to the sky. At that time, the layer 8 burns out without developing color.

In the case of the rocket firework, in order to increase a diameter of a firework at flowering (expanding) time, it is necessary to enlarge the firework ball to increase an amount of explosive powder and so on. However, it makes the firework ball heavy, and therefore, it becomes difficult to launch the firework ball to a high altitude in the sky. In fact, although it was planned to launch a firework ball (having a diameter of about 130 cm) which is estimated to have a diameter of about 1 km at the flowering time, the firework ball was too heavy and the accident occurred such that the firework ball did not rise to the sky but exploded in the water.

Further, the timing when a firework flowers (a firework ball bursts) is determined by a time period after the explosive powder for launch is ignited and the fuse starts burning until the split explosive catches fire. Accordingly, there is a risk that the firework ball does not burst at a predetermined altitude or that an accident occurs in the case of failing launch of the firework ball.

### PATENT DOCUMENT LIST

[Patent Document 1] Japanese Patent Application Publication JP-P2010-18271A (paragraphs 0006-0007, 0025, and FIG. 2)

### [Patent Document 2] Japanese Patent Application Publication JP-P2011-196668A (Abstract and FIG. 1)

### SUMMARY OF THE INVENTION

The present invention has been achieved in view of the above-mentioned points. A first purpose of the present invention is to provide a lunar base supply method which enables supplying a base on a surface of the moon more easily than carrying materials from the earth to the moon and building the base on the surface of the moon. Further, a second purpose of the present invention is to provide a light indication method which enables indicating light safely and reliably by sending a light source such as a firework ball toward the sky of an objective point. Furthermore, a third purpose of the present invention is to provide a firework ball in which the timing of burst can be adjusted from the outside or automatically.

In order to accomplish at least one of the above-mentioned purposes, a lunar base supply method according to a first aspect of the present invention is a method of supplying a base on a surface of the moon, and includes the steps of: (a) carrying materials to be used to build a structure to sky of the earth, and causing the materials to revolve along an orbit around the earth; (b) building the structure by using the materials on the orbit around the earth; and (c) moving the built structure from the orbit around the earth toward the moon, and causing the built structure to make a soft landing onto a surface of the moon and thereby to be available as a base.

According to the first aspect of the present invention, since the structure is built while the materials revolve along the orbit around the earth, an attracting force of the earth and a centrifugal force due to the revolving motion both affecting the materials match with each other to make a weightless state, and therefore, it is possible to reduce the force needed for moving or constructing the materials. Further, since the orbit around the earth is much closer to the earth than the moon, it is possible to supply the base on the surface of the moon more easily than carrying the materials from the earth to the moon and building the base on the surface of the moon, and thereby to reduce space development expenses significantly and shorten work time significantly.

Further, a light indication method according to a second aspect of the present invention is a method of indicating light in sky of an objective point, and includes the steps of: (a) mounting a light source in a flying object; and (b) launching the light source from the flying object, which is flying over the earth, toward sky of an objective point, and causing the light source to emit light in the sky of the objective point.

According to the second aspect of the present invention, by launching the light source from the flying object, which is mounting the light source and flying over the earth, toward the sky of the objective point, and causing the light source to emit light in the sky of the objective point, it is possible to indicate light safely and reliably in the sky of the objective point.

Here, the light source may include a firework ball; and step (b) may include igniting split explosive included in the firework ball when an altitude of the firework ball is within a predetermined range. Alternatively, the light source may include a color developing material of a metal or a metallic compound for emitting light in a predetermined color due to flame color reaction when heated by adiabatic compression of atmosphere in contact therewith.

Furthermore, a firework ball according to a third aspect of the present invention includes: a case; a plurality of stars or childballs arranged in the case, each of the plurality of stars or child balls including explosive powder and at least one of metallic compound particles and metal particles; split explosive arranged between the plurality of stars or child balls; an ignition member for generating heat when supplied with an ignition current to ignite the split explosive; and an ignition device for receiving a control signal transmitted wirelessly, and supplying the ignition current to the ignition member according to the control signal.

According to the third aspect of the present invention, since the firework ball is provided with the ignition member for generating heat when supplied with an ignition current to ignite the split explosive, and the ignition device for receiving a control signal transmitted wirelessly, and supplying the ignition current to the ignition member according to the control signal, it is possible to provide a firework ball in which the timing of burst can be adjusted from the outside.

### BRIEF DESCRIPTION OF THE DRAWINGS

FIG. 1 is a flowchart showing a lunar base supply method according to a first embodiment of the present invention;

FIG. 2 is a schematic drawing for schematically showing a space station and a landing assist apparatus to be used in a lunar base supply method according to a second embodiment of the present invention;

FIG. 3 is a schematic drawing for explaining a light indication method according to a third embodiment of the present invention;

FIG. 4 is a flowchart for showing the light indication method according to the third embodiment of the present invention;

FIG. 5 is a partial sectional view for showing an example of a configuration of a firework ball according to a fourth embodiment of the present invention;

FIG. 6 is a block diagram for showing a first example of a configuration of an ignition device together with an ignition member as shown in FIG. 5;

FIG. 7 is a block diagram for showing a second example of the configuration of the ignition device together with the ignition member as shown in FIG. 5;

FIG. 8 is a partial sectional view for showing an example of a configuration of a firework ball according to a fifth embodiment of the present invention; and

FIG. 9 is a schematic drawing for schematically showing an example of a configuration of a light source according to a sixth embodiment of the present invention.

### DESCRIPTION OF THE PREFERRED EMBODIMENTS

Hereinafter, some embodiments of the present invention will be explained in detail with reference to the drawings. The same reference characters are assigned to the same component elements and the explanation thereof will be omitted.

### <Lunar Base Supply Method 1>

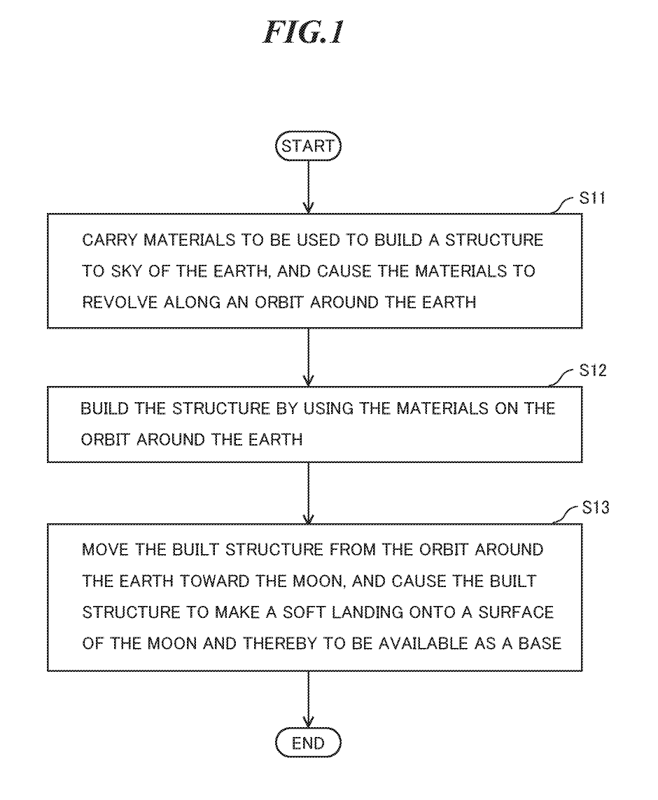

Firstly, embodiments of a lunar base supply method will be explained. FIG. 1 is a flowchart showing a lunar base supply method according to a first embodiment of the present invention. At Step S1 as shown in FIG. 1, a flying object carries materials to be used to build a structure to sky of the earth, and causes the materials to revolve along an orbit around the earth. In the present application, the “structure” may be a base facility or a portion thereof to be established on a surface of the moon, or a newly built space station or a portion thereof.

As the above-mentioned flying object, a spacecraft, a space station, an artificial satellite, a rocket, an airplane, and so on can be used. For example, the materials to be used to build the structure are mounted in the spacecraft, and the spacecraft is launched from a launching point in a coastal area along a flight path. Then, the spacecraft is controlled to go into an orbit around the earth, and when the spacecraft goes into the orbit around the earth, a rocket engine of the spacecraft is stopped.

As the orbit around the earth, the orbit at an altitude within a range from about 160 km to about 20,000 km measured from an average sea surface of the earth is suitable. For example, a circular orbit at an altitude of about 400 km may be set up. The spacecraft revolves around the earth at a lap speed at which an attracting force of the earth and a centrifugal force due to the revolving motion match with each other.

At Step S12 as shown in FIG. 1, operators build the structure by using the materials on the orbit around the earth. For example, the materials to be used to build the structure are carried from the spacecraft to outer space, and the structure is built in outer space. On the orbit around the earth, an attracting force of the earth and a centrifugal force due to the revolving motion both affecting the materials match with each other to make a weightless state, and therefore, it is possible to reduce the force needed for moving or constructing the materials.

Alternatively, the space station supply machine “Kounotori” or the like may carry the materials to Japanese laboratory “Kibo” of the International Space Station, and operators may build the structure by using the materials while operating a robot arm provided to “Kibo”. “Kibo” has two experiment spaces of an inboard laboratory and an outboard experiment platform. Since the inboard laboratory is provided with air lock equipment, it is possible to insert or remove the materials or the structure from or to the outboard experiment platform through the air lock equipment by operating the robot arm.

At Step S13 as shown in FIG. 1, operators move the built structure from the orbit around the earth toward the moon, and cause the built structure to make a soft landing onto a surface of the moon without destroying the built structure and thereby to be available as a base. For this purpose, a spacecraft equipped with a rocket engine may be used, or at least one booster rocket (a rocket engine separable after use) for providing a propulsion force or a braking force may be attached to the structure itself.

According to the first embodiment of the present invention, since the structure is built while causing the materials to revolve along the orbit around the earth, an attracting force of the earth and a centrifugal force due to the revolving motion both affecting the materials match with each other to make a weightless state, and therefore, it is possible to reduce the force needed for moving or constructing the materials. Further, since the orbit around the earth is much closer to the earth than the moon, it is possible to supply the base on the surface of the moon more easily than carrying the materials from the earth to the moon and building the base on the surface of the moon, and thereby to reduce space development expenses significantly and shorten work time significantly.

### <Lunar Base Supply Method 2>

Next, a lunar base supply method according to a second embodiment of the present invention will be explained. The lunar base supply method according to the second embodiment is a specific method of moving a structure revolving along an orbit around the earth to a surface of the moon, and causing the structure to make a soft landing thereon. As this structure, the structure which is built according to the lunar base supply method according to the first embodiment (and may include a space station) may be used, or an existing space station may be used.

Although the space stations in operation are managed by respective countries at great expense, they will retire from service in approximately five years from starting operation. If the retired space station is moved to the surface of the moon and reused, it is possible to significantly reduce cost and work time to provide a base on the moon without wasting resources. Hereinafter, as an example, the case of moving an existing space station revolving along the orbit around the earth to the surface of the moon, and using it as a lunar base will be explained.

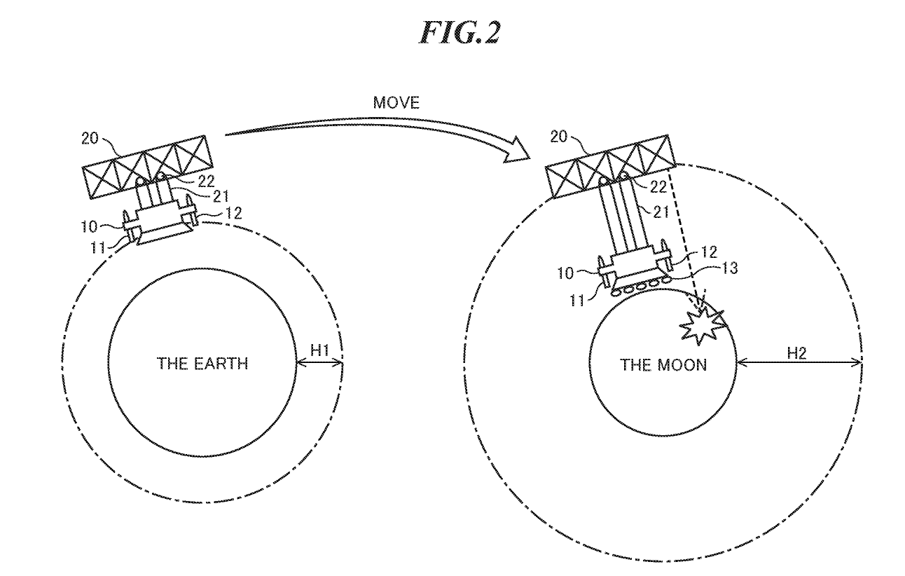

FIG. 2 is a schematic drawing for schematically showing a space station and a landing assist apparatus to be used in a lunar base supply method according to a second embodiment of the present invention. A space station 10 to be used in the embodiment is revolving along an orbit (a long dashed short dashed line in the drawing) around the earth. As an altitude H1 of the orbit measured from an average sea surface of the earth, a range from about 160 km to about 20,000 km is suitable. For example, a circular orbit at an altitude of about 400 km may be set up. In the case where the space station 10 flies along the circular orbit at an altitude of about 400 km, it takes about 90 minutes to go once around the earth.

The space station 10 includes at least one booster rocket (FIG. 2 shows, for example, two booster rockets 11 and 12) for providing a propulsion force or a braking force to the space station 10 in outer space, and a plurality of air bags 13 for mitigating a shock of landing when the space station 10 makes a soft landing on a surface of the moon.

The space station 10 is used as a main apparatus, and in order to cause the main apparatus to make a soft landing on the surface of the moon and to be available as a base, a landing assist apparatus 20 for reducing a fall velocity of the main apparatus at the landing time of the main apparatus is used as a sub apparatus (ancillary apparatus). The landing assist apparatus 20 includes a wire rope 21 having a predetermined length (e.g., 5 km to 10 km), and a winding machine 22 for winding or sending the wire rope 21.

For example, a terminal fixed to one end of the wire rope 21 is magnetically or mechanically connected to the space station 10. The winding machine 22 includes an inverter circuit for converting a DC voltage supplied from a storage battery mounted in the landing assist apparatus 20 into an AC voltage, and a motor for turning a winding reel according to the AC voltage supplied from the inverter circuit. Further, the winding machine 22 is configured to be remote-controlled wirelessly from the space station 10.

When the space station 10 revolves along the orbit around the earth, the winding machine 22 winds the wire rope 21, one end of which is connected to the space station 10, to join the space station 10 and the landing assist apparatus 20 together. Thereby, it is possible to make the landing assist apparatus 20 adhere to the space station 10.

In that state, at least one booster rocket 11 and/or 12 provided to the space station 10 operates to accelerate the space station 10, and moves the space station 10 and the landing assist apparatus 20 from the orbit around the earth toward the moon. The transfer toward the moon may be performed slowly for several weeks.

When the space station 10 and the landing assist apparatus 20 come near to the moon, at least one booster rocket 11 and/or 12 operates to decelerate the space station 10, and causes the space station 10 and the landing assist apparatus 20 to revolve along an orbit (a long dashed short dashed line in the drawing) around the moon.

As an altitude H2 of the orbit measured from an average ground surface of the moon, an altitude within a range from about 40 km to about 5,000 km is suitable. For example, a circular orbit at an altitude of 100 km may be set up. The space station 10 and the landing assist apparatus 20 revolve around the moon at a lap speed at which an attracting force of the moon and a centrifugal force due to the revolving motion match with each other.

On the orbit around the moon, at least one booster rocket 11 and/or 12 operates and the winding machine 22 sends the wire rope 21, and thereby, a distance between the space station 10 and the landing assist apparatus 20 is adjusted to expand to a predetermined distance (e.g., 5 km to 10 km). At that time, it is desirable that the space station 10 is located nearer to the surface of the moon than the landing assist apparatus 20, and that the space station 10 and the landing assist apparatus 20 are arranged substantially on the vertical line.

Further, at least one booster rocket 11 and/or 12 operates to reduce a lap speed of the space station 10 and the landing assist apparatus 20 so that the space station 10 and the landing assist apparatus 20 fall toward the surface of the moon. Immediately after the start of the falling, a fall velocity of the space station 10 and a fall velocity of the landing assist apparatus 20 are substantially equal to each other.

While the space station 10 and the landing assist apparatus 20 are falling toward the surface of the moon, the winding machine 22 winds the wire rope 21 so as to reduce a distance between the space station 10 and the landing assist apparatus 20 and also reduce a fall velocity of the space station 10.

Here, it is desirable that a mass of the landing assist apparatus 20 is not less than 1/10 of a mass of the space station 10 and not more than the mass of the space station 10, and the mass of the landing assist apparatus 20 may be substantially equal to the mass of the space station 10.

For example, when the space station 10 comes near to the surface of the moon by a first distance (e.g., several kilometers to several dozens of kilometers), the winding machine 22 starts winding the wire rope 21.

Further, when the space station 10 comes near to the surface of the moon by a second distance (e.g., about 500 m), the space station 10 separates the landing assist apparatus 20. For example, in the case where the terminal of the wire rope 21 is magnetically or mechanically connected to the space station 10, the space station 10 can separate the landing assist apparatus 20 smoothly by canceling the magnetic or mechanical connection.

When separating the landing assist apparatus 20, it is desirable that the space station 10 causes at least one booster rocket 11 and/or 12 to operate to shift a location of the space station 10 and a location of the landing assist apparatus 20 in a horizontal direction so that the space station 10 and the landing assist apparatus 20 never collide with each other.

The landing assist apparatus 20 collides, when separated from the space station 10, with the surface of the moon vigorously. In the case where the landing assist apparatus 20 is manufactured by connecting plates of metal such as aluminum, an aluminum alloy, or stainless steel by using bolts and nuts, etc., even if the landing assist apparatus 20 is seriously damaged, component parts of the landing assist apparatus 20 can be reused as materials of architecture and so on. On the other hand, a fall velocity of the space station 10 is reduced, and therefore, the space station 10 falls relatively slowly.

In this way, the space station 10 makes a soft landing onto the surface of the moon. Although an attracting force of the moon is about ⅙ of that of the earth and the space station 10 falls relatively slowly, it is desirable to cause at least one booster rocket 11 and/or 12 to operate so that the space station 10 falls more slowly. The space station 10 blows up a plurality of air bag 13 to mitigate a shock of landing. After the space station 10 has made a soft landing onto the surface of the moon, it becomes available as a base on the moon.

### <Light Indication Method>

A light indication method according to a third embodiment of the present invention is a method of sending a light source toward the sky of an objective point by utilizing a flying object flying over the earth so as to indicate light in the sky of the objective point, in order to inform opening of an event such as the Olympic Games or the World Cup, or draw a diagram or characters representing an advertisement in the sky, for example.

For example, a firework ball may be used as the light source, and a firework for drawing the five-ring Olympic emblem or the like may be sent toward the sky of the Olympics site as an opening ceremony of the Olympic Games. Alternatively, a color developing material for emitting light due to flame color reaction when heated by adiabatic compression of atmosphere in contact therewith may be used as the light source, and various light developing materials, which become like shooting stars in accordance with contents of the event, may be sent toward the sky of the event site.

As the above-mentioned flying object, a space station, an artificial satellite, a rocket, an airplane, and so on can be used. For example, the space station or the artificial satellite revolving along an orbit around the earth flies over the earth at a lap speed at which an attracting force of the earth and a centrifugal force due to the revolving motion match with each other. Hereinafter, the case where a space station such as the International Space Station is used as one example of the flying object will be explained.

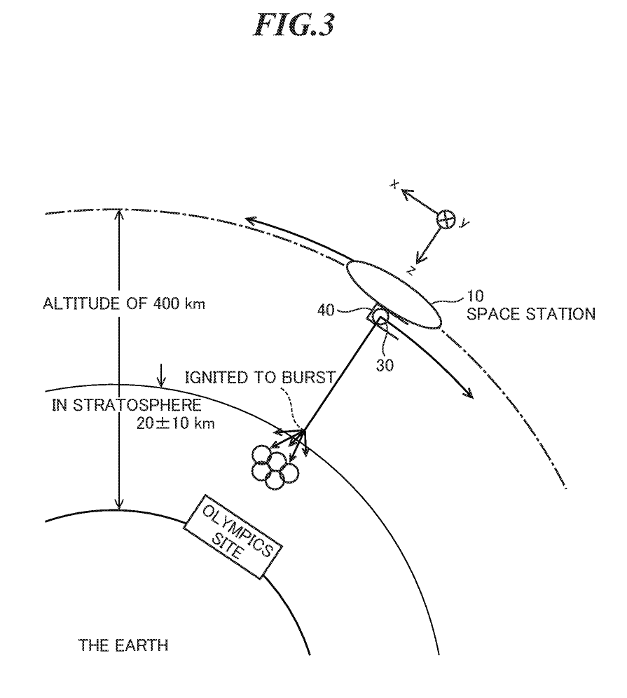

FIG. 3 is a schematic drawing for explaining a light indication method according to a third embodiment of the present invention. As shown in FIG. 3, the space station 10 revolves around the earth at a velocity of about 7.7 km/sec along a circular orbit having an altitude of about 400 km, and goes once around the earth in about 90 minutes. Since the earth rotates while the space station 10 goes around the earth, the orbit of the space station 10 shifts gradually with respect to the earth, and there is a time period in which the space station 10 passes through the sky of the objective point or its periphery. In that time period, a light source 30 is launched by using a launching cylinder 40, for example.

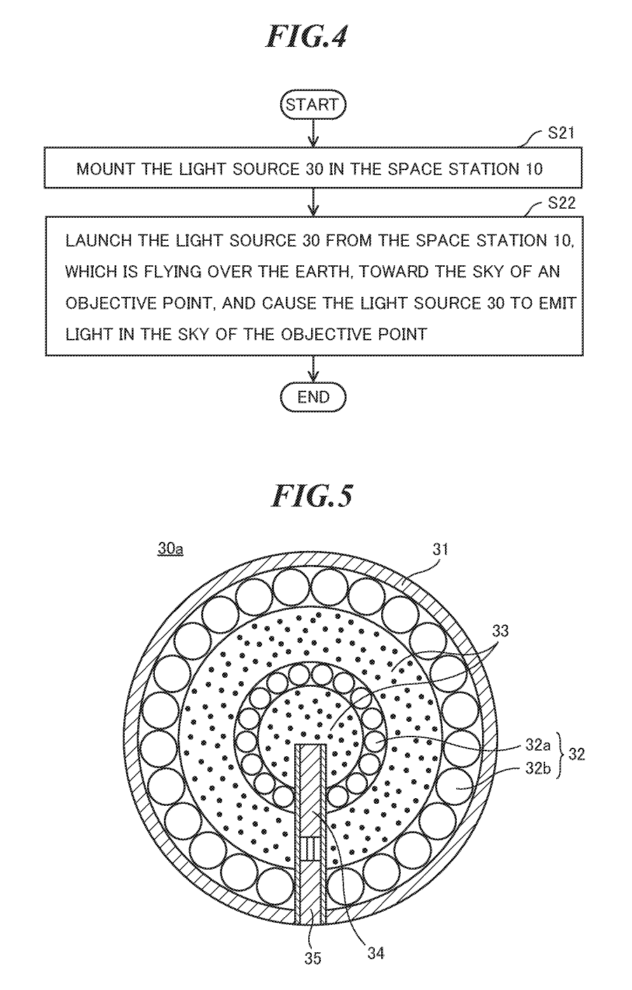

FIG. 4 is a flowchart for showing the light indication method according to the third embodiment of the present invention. At Step S21 as shown in FIG. 4, the light source 30 is mounted in the space station 10. Further, in this embodiment, the launching cylinder 40 for launching the light source 30 is also mounted in the space station 10.

For example, the space station supply machine “Kounotori” or the like may be used to carry the light source 30 and the launching cylinder 40 to the space station 10 revolving along an orbit around the earth. Further, in the case where an airplane or the like is used as the flying object, the light source 30 and the launching cylinder 40 may be mounted in the flying object before the flying object takes off.

The launching cylinder 40 is attached to the outside of the space station 10 in the state where an opening of the launching cylinder 40 is turned in a predetermined direction. For example, explosive powder for launch is filled on a bottom of the launching cylinder 40, and an electric fuse is connected to the explosive powder for launch. Further, the light source 30 is loaded in the launching cylinder 40. On the orbit around the earth, an attracting force of the earth and a centrifugal force due to the revolving motion both affecting the light source 30 or the launching cylinder 40 match with each other to make a weightless state, and therefore, it is possible to reduce the force needed for moving or constructing the light source 30 or the launching cylinder 40.

At Step S22 as shown in FIG. 4, the light source 30 is launched from the space station 10, which is flying over the earth, toward the sky of an objective point, and the light source 30 is caused to emit light in the sky of the objective point. For example, by operating a control unit provided within the space station 10 to apply an electrical current to the electric fuse, the electric fuse generates heat to ignite the explosive powder for launch, and thereby, the light source 30 can be launched. Since the explosive powder itself includes both a flammable agent and an oxygen carrier, it is possible to use the explosive powder in outer space where no air exists. Alternatively, a launching mechanism for mechanically launching the light source 30 may be provided within the launching cylinder 40.

A launching direction, a launching velocity, and launching timing of the light source 30 are previously calculated based on a location and a velocity of the space station 10 and a location of the sky of the objective point. Here, the location of the space station 10 is represented as a function of time. For example, the launching direction, the launching velocity, and the launching timing of the light source 30 may be determined such that path length of the light source 30 becomes shortest.

Given that a velocity of the space station 10 in a rectangular coordinate system (x, y, z) including a traveling direction “x” of the space station 10 and a vertical direction “z” is represented as “vₓ”, in the case of launching the light source 30 in an opposite direction to the traveling direction “x” at a launching velocity of −vₓ with respect to the space station 10, it is possible to set an initial velocity of the light source 30 as seen from the earth to zero to eliminate an effect of the centrifugal force so that the light source 30 falls freely.

In actuality, since it is necessary to launch the light source 30 toward a predetermined altitude in the sky of the objective point, the light source 30 performs accelerated motion in a vertical direction by a difference between an attracting force of the earth and a centrifugal force, and performs uniform motion in a horizontal direction. Accordingly, the light source 30 reaches the sky of the objective point while drawing an orbit of a parabola.

Thus, in the case of launching the light source 30 from the space station 10, the accident that the light source 30 collides with the space station 10 does not occur. Further, by determining an orbit of the light source 30 to avoid previously grasped orbits of artificial satellites of various countries, it is possible to launch the light source 30 while avoiding the risk of collision with the artificial satellites flying over the earth.

Instead of launching the light source 30 by using the launching cylinder 40, the light source 30 may be thrown down or dropped from the space station 10. At that time, the light source 30 may be lowered by connecting the light source 30 to a tip of a tether and sending the tether out from the space station 10. The light source 30 or the tether is detached from the space station 10 when the light source 30 reaches a predetermined altitude. Thereby, it is possible to limit a fall velocity of the light source 30.

Alternatively, an artificial satellite, a small-sized rocket, or the like mounting the light source 30 may be launched from the space station 10 to carry the light source 30 to a relatively low altitude. In that case, the artificial satellite, the rocket, or the like slowly descends while retro-firing, and when it reaches a predetermined altitude (e.g., about 10 km to about 100 km), the light source 30 is thrown down.

As expressed by the next expression (1), an atmospheric density “ρ” around the earth is the thickest (ρ=ρ₀) at an altitude of zero (h=0) measured from an average sea surface of the earth, and it becomes thinner exponentially as the altitude “h” increases.

ρ=ρ₀ exp(−h/h₀) (1)

Here, “h₀” is a constant (equal to about 8 km).

The atmospheric pressure at a certain altitude is proportional to atmospheric weight above it. The atmospheric pressure becomes approximately a one-tenth every altitude of 15 km, and approximately 90% of atmospheric air exists within an altitude of 15 km. Therefore, at an altitude (e.g., not higher than about 15 km) where atmospheric air exists with a density of some degree, it is possible to reduce a fall velocity of the light source 30 by using a parachute. However, in that case, a velocity of the light source 30 fluctuates due to air resistance and weather condition, and therefore, it is desirable to put influences of air resistance and weather condition into a calculation for obtaining an orbit of the light source 30.

In the case where the light source 30 includes a firework ball, at Step S22 as shown in FIG. 4, split explosive included in the firework ball may be ignited when an altitude of the firework ball is within a predetermined range. Thereby, the wirework ball bursts, that is, the firework expands at an altitude within a predetermined range in the sky of an objective point. For example, light representing the five-ring Olympic emblem or the like is indicated in the sky of the Olympics site. In this way, even if a large-size firework ball is used, it is possible to cause the firework ball to burst stably at a predetermined altitude.

Here, the predetermined range may be an altitude of about 10 km to about 30 km measured from an average sea surface of the earth. This altitude range is included in the stratosphere where the weather is not so active than that in the troposphere at an altitude not higher than about 10 km, and the atmospheric pressure is lower and the air resistance is smaller than those at a lower altitude, and therefore, it is possible to cause a firework having a large diameter to expand relatively stably.

In order to cause the firework ball as the light source 30 to burst, an ignition device for receiving a control signal transmitted wirelessly may be built in the light source 30, and the ignition device may be controlled wirelessly from a control device, which is installed in the space station 10 or on the ground, to ignite the split explosive. For example, by tracking a location of the light source 30 from the space station 10 or the ground, the ignition device may be controlled to ignite the split explosive when the altitude of the light source 30 is within a predetermined range.

Alternatively, since the altitude of the light source 30 can be calculated as a function of time, a time period after the light source 30 is launched until the altitude of the light source 30 becomes within the predetermined range may be obtained by a calculation, and the ignition device may be controlled to ignite the split explosive when the time period has elapsed after the light source 30 is launched.

As another example, an ignition device for measuring an altitude of the light source 30 may be built in the light source 30, and the ignition device may automatically ignite the split explosive when the measured altitude is within a predetermined range. For example, the ignition device may include a GPS (Global Positioning System) receiver, and calculate a location of the light source 30 based on signals received from GPS satellites so as to measure the altitude of the light source 30. Alternatively, the ignition device may include an altimeter for measuring the altitude of the light source 30.

Further, the light source 30 may include a color developing material of a metal or a metallic compound for emitting light in a predetermined color due to flame color reaction when heated by adiabatic compression of atmosphere in contact therewith. The individual color developing material may have a substantially spherical shape. It is necessary for the individual color developing material to have such a size that it burns out, when heated by adiabatic compression of atmosphere in contact therewith, before it reaches the ground level.

For example, by sequentially launching various color developing materials toward the sky of an event site in accordance with contents of the event, those color developing materials emit light due to flame color reaction, and the light that looks like shooting stars is indicated in the sky of the event site. Here, as the metal or the metallic compound indicating flame color reaction, the materials described in a fourth embodiment can be used.

Thus, in accordance with the light indication method according to the third embodiment of the present invention, by launching the light source 30 from the flying object such as the space station 10, which is mounting the light source 30 and flying over the earth, toward the sky of an objective point, and causing the light source 30 to emit light in the sky of the objective point, it is possible to indicate light safely and reliably in the sky of the objective point.

### <Firework Ball>

Next, a firework ball according to some embodiments of the present invention will be explained. Although the firework ball as explained below is suitable to be used as the light source in the light indication method according to the third embodiment of the present invention, the firework ball may be launched according to other methods.

### Fourth Embodiment

FIG. 5 is a partial sectional view for showing an example of a configuration of a firework ball according to a fourth embodiment of the present invention. As shown in FIG. 5, a firework ball 30a includes a case (ball skin) 31, a plurality of stars 32, split explosive 33, an ignition member 34, and an ignition device 35. Further, a diameter of the firework ball 30a may be larger than 120 cm (Model No. 40).

The case 31 is, for example, a spherical capsule, and is configured of plural parts (e.g., two parts). When manufacturing the firework ball 30a, the plurality of stars 32 and the split explosive 33, etc. are packed into the separated plural parts of the case 31, then the plural parts are combined with each other and sealed, and thereby, the spherical capsule is constituted. Further, an opening for exposing a part of the ignition device 35 may be formed in the case 31.

In the case where launching of the firework ball 30a is performed at a relatively high altitude, the case 31 is overheated by adiabatic compression of atmosphere in contact therewith until the firework ball 30a reaches the sky of an objective point, and therefore, it is desirable to employ metal, ceramic, or the like having excellent heat resistance as a material of the case 31. On the other hand, in the case where launching of the firework ball 30a is performed at a relatively low altitude, paper or plastic may be employed as a material of the case 31.

The plurality of stars 32 are arranged in the case 31. In order to draw a figure or letters in the sky by using the light in a desired color when the firework expands, each of the plurality of stars 32 includes explosive powder such as black powder, and metallic compound particles or metal particles. In the example as shown in FIG. 5, the plurality of stars 32 are arranged in plural layers, and include plural stars 32a arranged in the inside first layer and plural stars 32b arranged in the second layer located outside than the first layer.

For example, the plurality of stars 32 are manufactured by mixing a binder, etc. with the explosive powder and the metallic compound particles or the metal particles, and molding the mixture into a spherical shape, a cuboid shape, a tablet shape, or the like. The metallic compound particles or the metal particles play a role to produce a desired color due to flame color reaction of the metal. For that reason, an appropriate material is chosen depending on a color to be produced due to flame color reaction. Further, in order to change a color of light emission while the star 32 is burning, plural layers including particles of different materials may be provided in each of the stars 32.

In order to produce elementary four colors, the next metal compounds can be used.
crimson (red): strontium carbonate (SrCO₃)
yellow: sodium oxalate (Na₂C₂O₄)
green: barium nitrate (Ba(NO₃)₂)
blue: copper oxide (CuO)
   Further, it is possible to blend the elementary four colors to produce various colors such as purple, pink, light blue, and so on.

Alternatively, metals can be used instead of the metal compounds. For example, in order to produce various colors, the next metals can be used.
crimson (red): strontium (Sr)
red: lithium (Li)
reddish purple: potassium (K)
orange: calcium (Ca)
yellow: natrium (Na)
green: barium (Ba)
blue: copper (Cu)
gold: titanium alloy (Ti—X)
silver (white): aluminum (Al)

In order to lengthen the color development continuation time of the stars 32, each of the stars 32 may include plural kinds of particles having different particle sizes. For example, each of the stars 32 may include a first group of particles each having a particle size in a first range usually used, and a second group of particles each having a particle size in a second range that is larger than the first range. Thereby, it is possible to make a difference between the time when the first group of particles burn out and the time when the second group of particles burn out.

Alternatively, each of the stars 32 may include a first group of particles of metallic compound (e.g., granulated balls) each having a particle size in a first range, and a second group of particles of metal (e.g., metal balls) each having a particle size in a second range that is larger than the first range. Thereby, it is possible to further lengthen the color development continuation time of the stars 32.

In the above, for example, the first range may be set larger than zero and not larger than 1 mm, and the second range may be set larger than 1 mm and not larger than 3 mm or 5 mm. Alternatively, the first range may be set larger than zero and not larger than 3 mm, and the second range may be set larger than 3 mm and not larger than 5 mm. In addition, the first group of particles may be used in the stars 32a arranged in the first layer, and the second group of particles may be used in the stars 32b arranged in the second layer. Thereby, it is possible to increase a diameter of the firework at flowering (expanding) time so that the firework can be viewed easily even from the distance.

The split explosive 33 is, for example, cotton seeds or the like coated with black powder, and arranged between the plurality of stars 32. Further, a partition plate made of paper, plastic, metal, or the like may be provided between a layer in which the stars 32 are arranged and a layer in which the split explosive 33 is disposed. The split explosive 33 has a role to burst, when ignited, to break the case 31, and ignite the plurality of stars 32 and scatter them in many directions. Thereby, the stars 32 are scattered while the explosive powder contained in the stars 32 is burning. At that time, the metallic compound particles or the metal particles contained in the stars 32 are heated and melted to emit light in predetermined colors, further, the atmosphere in contact with the particles generates heat by adiabatic compression so that the light emission is continued, and thereby, the firework can be viewed for a long time.

The ignition member 34 includes, for example, an ignition ball or an electric lead wire to be used in ignition by electricity, and generates heat when supplied with an ignition current to ignite the split explosive 33. The ignition ball is configured, for example, such that two electrodes are connected to an explosive part covered with a reinforcing film. By supplying electricity to wiring cords connected to the electrodes, the explosive part generates heat and catches fire to ignite the split explosive 33 in turn. Such an ignition ball is directly inserted into the split explosive 33, or inserted into one end of a quick match extended from the split explosive 33.

Alternatively, an electric fuse having a pipe-like protective cap attached to outside of the ignition ball for reinforcement may be used. In this case, the ignition ball is included in the protection cap without being exposed, and therefore, the safety of handling with respect to impact and friction becomes higher. Further, the spark generated from the ignition ball does not diffuse in many directions but flies with concentration toward the opening part of the pipe (at the opposite side to the wiring cords), and therefore, the reliability of the ignition becomes higher.

### <Ignition Device 1>

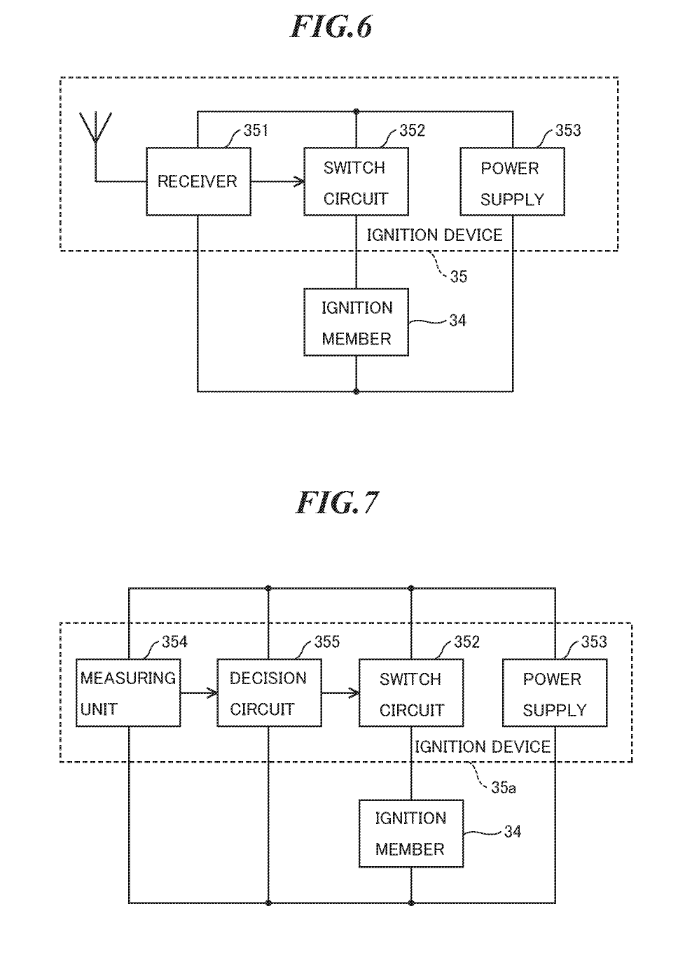

FIG. 6 is a block diagram for showing a first example of a configuration of the ignition device together with the ignition member as shown in FIG. 5. The ignition device 35 as shown in FIG. 6 receives a control signal transmitted wirelessly, and supplies the ignition current to the ignition member 34 according to the control signal. As shown in FIG. 6, the ignition device 35 includes a receiver 351, a switch circuit 352, and a power supply 353.

The receiver 351 includes an antenna, receives a control signal transmitted wirelessly from a control device provided in the space station 10 or on the ground, and controls the switch circuit 352 to a conductive state in accordance with a control signal representing an ignition instruction. Alternatively, a transmitting/receiving device may be provided in place of the receiving device 351, and the transmitting/receiving device transmits a position signal wirelessly so that the position of the firework ball 30a can be tracked from the space station 10 or the ground.

The switch circuit 352 includes, for example, a transistor, a relay, or the like, and applies, when brought into a conductive state, a DC voltage supplied from the power supply 353 to the ignition member 34 so as to supply the ignition current to the ignition member 34. The power supply 353 includes, for example, a storage battery, a capacitor having large capacitance, or the like, and supplies the DC voltage to the receiver 351 and the switch circuit 352 as needed.

Referring again to FIG. 5, since the ignition device 35 supplies the ignition current to the ignition member 34, the ignition member 34 ignites the split explosive 33. Thereby, the split explosive 33 explodes and breaks the case 31, and the plurality of stars 32 ignited from the split explosive 33 are scattered in many directions while burning. In this way, the firework ball 30a can be ruptured in the sky of the objective point.

In the above, by using a firework ball called “molded object” for drawing a desired pattern or the like in the sky by a firework, the firework ball 30a may draw, when ignited to burst, a desired figure or characters in the sky of the objective point by a firework. For example, as an opening ceremony of the Olympic Games, the five-ring Olympic emblem can be drawn in the sky (e.g., at an altitude of about 10 km to about 30 km) of the Olympics site by a firework. Especially, at an altitude of about 10 km to about 30 km, the atmospheric pressure is lower and the air resistance is smaller than those at a low altitude, and therefore, it is possible to draw the five-ring Olympic emblem having a large diameter. Thus, suitably for a national festival, a large number of people are able to observe the five-ring Olympic emblem.

The five-ring Olympic emblem has a shape in which monochromatic or five-color (from left: blue, yellow, black, green, and red) rings are overlapped and coupled. In the case where the five-color rings are represented by a firework, black is replaced with another color (e.g., purple). Further, in order to align a direction of the five-ring emblem in a predetermined direction, a posture control member (a strap, a tail, an arrow, a pipe, or the like) for controlling a posture of the firework ball 30a when the firework ball 30a falls in the air may be attached to a predetermined portion of the case 31.

In this way, since the firework ball 30a (FIG. 5) is provided with the ignition member 34 for generating heat when supplied with an ignition current to ignite the split explosive 33, and the ignition device 35 for receiving a control signal transmitted wirelessly, and supplying the ignition current to the ignition member 34 according to the control signal, it is possible to provide the firework ball 30a in which the timing of the rupture can be adjusted from the outside.

### <Ignition Device 2>

FIG. 7 is a block diagram for showing a second example of the configuration of the ignition device together with the ignition member as shown in FIG. 5. In the second example, the ignition device 35a as shown in FIG. 7 is used in place of the ignition device 35 as shown in FIG. 6.

The ignition device 35a as shown in FIG. 7 measures an altitude of the firework ball 30a, and supplies the ignition current to the ignition member 34 in the case where the measured altitude is within a predetermined range. As shown in FIG. 7, the ignition device 35a includes a measuring unit 354, a decision circuit 355, a switch circuit 352, and a power supply 353.

The measuring unit 354 measures an altitude of the firework ball 30a, and outputs a measurement signal representing the measurement result. For example, a measuring unit 354 includes a GPS receiver, and calculates a position of the firework ball 30a on the basis of signals received from a plurality of GPS satellites to measure the altitude of the firework ball 30a, and output a measurement signal representing the altitude of the firework ball 30a.

Alternatively, the measuring unit 354 may include an altimeter such as a radio altimeter or a barometric altimeter. The radio altimeter measures the reflection time from a target by using a radio wave to measure a distance from the target. For example, the radio altimeter transmits a radio wave in a vertical direction to the ground, receives the radio wave reflected from the ground, and thereby measures a distance from the ground to the firework ball 30a on the basis of the time period from the transmission of the radio wave to the reception of the radio wave and outputs a measurement signal representing the altitude of the firework ball 30a. Further, the barometric altimeter is a kind of pressure gauge (barometer), and measures the pressure of the atmosphere which changes according to the altitude of the firework ball 30a, and thereby measures the altitude of the firework ball 30a and outputs a measurement signal representing the altitude of the firework ball 30a.

Based on the measurement signal output from the measurement unit 354, the decision circuit 355 controls the switch circuit 352 into a conductive state when the altitude measured by the measurement unit 354 is within a predetermined range. The switch circuit 352 applies, when brought into the conductive state, a DC voltage supplied from the power supply 353 to the ignition member 34, and thereby supplies the ignition current to the ignition member 34. The power supply 353 supplies the DC voltage to the measuring unit 354, the decision circuit 355, and the switch circuit 352 as needed.

In this way, since the firework ball 30a (FIG. 5) is provided with the ignition member 34 for generating heat when supplied with an ignition current to ignite the split explosive 33, and the ignition device 35a for measuring an altitude of the firework ball 30a, and supplying the ignition current to the ignition member 34 in the case where the measured altitude is within a predetermined range, it is possible to provide the firework ball 30a in which the timing of the rupture can be automatically adjusted.

### Fifth Embodiment

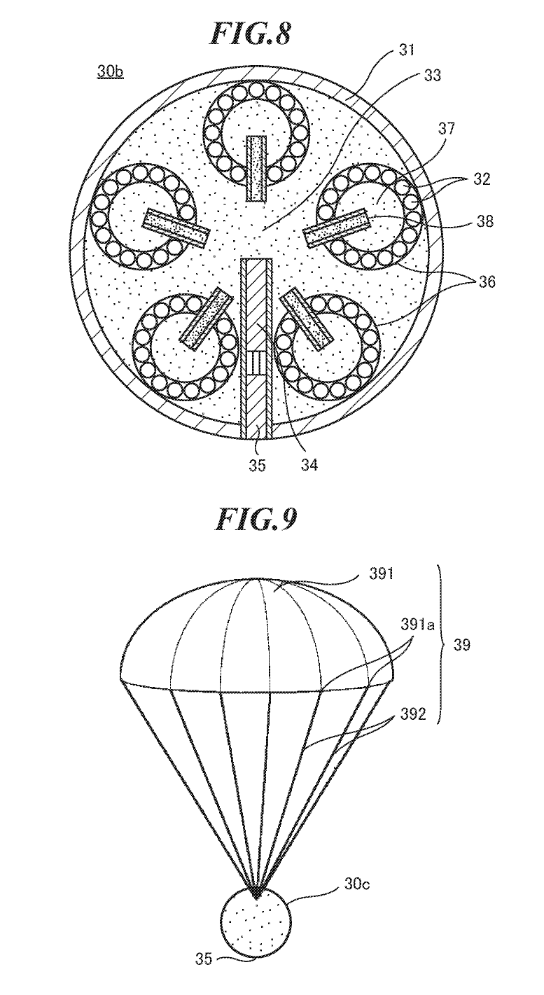

FIG. 8 is a partial sectional view for showing an example of a configuration of a firework ball according to a fifth embodiment of the present invention. As shown in FIG. 8, the firework ball 30b includes a case (ball skin) 31, a plurality of child balls 36, a split explosive 33 disposed between the plurality of child balls 36, an ignition member 34, and an ignition device 35. The child ball 36 corresponds to a smaller firework ball to be packed into a larger firework ball. Each of the child balls 36 includes a plurality of stars 32, a split explosive 37 disposed between the plurality of stars 32, and a fuse 38 connected to the split explosive 37. In other respects, the fifth embodiment may be the same as the fourth embodiment.

In the example as shown in FIG. 8, five child balls 36 corresponding to the five-ring Olympic emblem are packed into the case 31, and when the firework ball 30b is ignited to burst, the five-ring emblem can be drawn in the sky by a firework. As the childball 36, a firework ball called “molded object” for drawing a desired pattern or the like in the sky by a firework is used, and one child ball 36 is configured to draw one ring. In order to draw the five-color five-ring emblem, five child balls 36 include five kinds of stars 32 for emitting light in five colors, respectively.

Since the ignition device 35 supplies an ignition current to the ignition member 34, the ignition member 34 ignites the split explosive 33. Thereby, the split explosive 33 explodes and breaks the case 31, and the five child balls 36 having the fuses 38 ignited from the split explosive 33 are scattered in five directions. Further, the split explosive 37 included in each of the child balls 36 is ignited by the fuse 38 and explodes, and the plurality of stars 32 ignited from the split explosive 37 are scattered in many directions while burning. In this way, it is possible to cause the firework ball 30b to burst in the sky of the objective point and draw the five-ring emblem by a firework.

### <Light Source>

FIG. 9 is a schematic drawing for schematically showing an example of a configuration of a light source according to a sixth embodiment of the present invention. The light source according to the sixth embodiment is configured by attaching a parachute 39 to a light source main body 30c. The light source main body 30c may be a firework ball 30a according to a fourth embodiment, a firework ball 30b according to a fifth embodiment, or a color developing material of a metal or a metallic compound for emitting light in a predetermined color due to flame color reaction when heated by adiabatic compression of atmosphere in contact with the color developing material. The light source main body 30c with the parachute 39 attached thereto is thrown down from a flying object at a predetermined altitude.

A shape of the parachute 39 may be a mushroom type or a lamb air type. Although similar shapes are used for deceleration of a space shuttle, a fighter aircraft, or the like, they are used only for deceleration and referred to as a drag chute (a deceleration parachute). FIG. 9 shows, as an example, the parachute 39 of a mushroom type opened in the atmosphere.

As shown in FIG. 9, the parachute 39 includes, for example, an umbrella body 391 having a substantially circular shape in a plan view, and a plurality of hanging ropes 392 respectively connected to a plurality of umbrella edges 391a of the umbrella body 391. The umbrella body 391 and the hanging ropes 392 are made of, for example, flame-retardant chemical fiber or the like. One end of each of the hanging wires 392 is connected to the umbrella edge 391a, and the other end thereof is fixed to the light source main body 30c. In the light source main body 30c, it is desirable that the ignition device 35 is located on the opposite side of the portion to which the hanging ropes 392 are attached.

In the above, the case where the five-ring Olympic emblem or the like is drawn in the sky of the Olympics site by a firework, and the case where the light like shooting stars is drawn in the sky of the event site in accordance with contents of the event are explained. However, a logo mark (a figure or characters) of a sports event such as a world cup or other events may be drawn, or a figure or characters representing an advertisement of a company or the like may be drawn. Alternatively, a pattern such as a flower of cherry or a flower of chrysanthemum may be drawn for admiration.

Thus, the present invention is not limited to the above-mentioned embodiments, and many variations are possible within the technical concept of the present invention by a person having ordinary skill in the art. For example, a plurality of embodiments selected from among the above-mentioned embodiments can be implemented in combination.

1. A lunar base supply method of supplying a base on a surface of the moon, said method comprising the steps of:
(a) carrying materials to be used to build a structure to sky of the earth, and causing the materials to revolve along an orbit around the earth;
(b) building the structure by using the materials on the orbit around the earth; and
(c) moving the built structure from the orbit around the earth toward the moon, and causing the built structure to make a soft landing onto a surface of the moon and thereby to be available as a base.

2. A light indication method of indicating light in sky of an objective point, said method comprising the steps of:
(a) mounting a light source in a flying object; and
(b) launching the light source from the flying object, which is flying over the earth, toward sky of an objective point, and causing the light source to emit light in the sky of the objective point.

3. The light indication method according to claim 2, wherein:
said light source includes a firework ball; and
step (b) includes igniting split explosive included in the firework ball when an altitude of the firework ball is within a predetermined range.

4. The light indication method according to claim 2, wherein said light source includes a color developing material of a metal or a metallic compound for emitting light in a predetermined color due to flame color reaction when heated by adiabatic compression of atmosphere in contact therewith.

5. A firework ball comprising:
a case;
a plurality of stars or child balls arranged in the case, each of the plurality of stars or child balls including explosive powder and at least one of metallic compound particles and metal particles;
split explosive arranged between the plurality of stars or child balls;
an ignition member for generating heat when supplied with an ignition current to ignite the split explosive; and
an ignition device for receiving a control signal transmitted wirelessly, and supplying the ignition current to the ignition member according to the control signal.

6. A firework ball comprising:
a case;
a plurality of stars or child balls arranged in the case, each of the plurality of stars or child balls including explosive powder and at least one of metallic compound particles and metal particles;
split explosive arranged between the plurality of stars or child balls;
an ignition member for generating heat when supplied with an ignition current to ignite the split explosive; and
an ignition device for measuring an altitude of the firework ball, and supplying the ignition current to the ignition member in a case where the measured altitude is within a predetermined range.
